(19) United States
(12) Patent Application Publication
(10) Pub. No.: US 2010/0307218 A1
(43) Pub. Date: Dec. 9, 2010

(54) TORQUE-MEASURING DEVICE, TORQUE-MEASURING FLANGE AND TORQUE-MEASURING METHOD

(75) Inventors: Herbert Meuter, Herzogenrath (DE); Michael Koslowski, Herzogenrath (DE)

Correspondence Address: COLLARD & ROE, P.C., 1077 NORTHERN BOULEVARD, ROSLYN, NY, 11576, US

(73) Assignee: GIF Gesellschaft fuer Industrieforschung mbH, Alsdorf (DE)

(21) Appl. No.: 12/734,573

(22) PCT Filed: Nov. 13, 2008
(86) PCT No.: PCT/DE2008/001856

§ 371 Date: May 10, 2010

(30) Foreign Application Priority Data
Nov. 13, 2007 (DE) 102007054408.3
Jun. 19, 2008 (DE) 102008028826.8

(51) Int. Cl. G01L 25/00

(52) U.S. Cl. 73/1.09

(57) ABSTRACT

In order to minimize the risk of artifacts in a torque measuring device, a torque measuring flange and a torque measuring method, the invention proposes that the evaluation device has means for storing a variable which is proportional to a freewheel torque and means for compensating a measured value with the stored variable.

The invention relates to a torque-measuring device, a torque-measuring flange and a torque-measuring method.

Torque-measuring devices of this type are used for example in test benches, as are disclosed inter alia in DE 2006 044 829 A1. Here, torque-measuring flanges or torque-measuring shafts are used, as are disclosed for example in DE 42 03 551 A1 or DE 10 2007 005 894 A1, but also in DE 20 2006 007 689 U1, in DE 199 17 626 A1, DE 197 19 921 A1 and DE 103 06 306 A1, as well as in the Internet articles “Bedienungsanleitung Drehmomentmesswelle F1i/F2i [F1i/F2i torque-measuring shaft operation manual]” of the GIF Gesellschaft fur Industrieforschung mbH from Alsdorf in Germany (2007/Rev. 1.25) and “User's Manual TF Series Torque Flange Sensors” of Magtrol Inc. from New York in the United States of America (3 Jun. 2008), wherein the terns torque-measuring flange and-torque-measuring shaft are used synonymously in the present context. A torque is measured with test benches or arrangements or devices of this type, wherein it is predominantly the torques of rotating subassemblies which are measured in the present context. In particular, subassemblies of this type can be subjected to loading in a targeted manner during a rotation, in order to investigate the behaviour of the corresponding subassembly under loading, particularly with regards to its reaction through a changed torque. In this manner, wear, service life, behaviour under extreme loading, natural vibrations, clatter noises and the like can be investigated for example.

Here, DE 20 2006 discloses a torque-measuring shaft which inter alia has a digital interface and a temperature sensor for temperature-dependent zero-point compensation, that is to say the compensation of a temperature dependence of the measurement value output by the torque-measuring shaft, when no torque is present.

It is the object of the present invention to provide a torque-measuring device, a torque-measuring flange as well as a torque-measuring method for which the measurement of artefacts is minimised.

As a solution, the present invention first suggests a torque-measuring device with a torque-measuring flange and an evaluation system which stands out on account of the fact that the evaluation system has means for storing a value proportional to a freewheeling torque and means for the compensation of a measured value with the stored value.

Here, the invention proceeds from the fundamental insight that a torque-measuring flange in a freewheeling state, that is to say in a rotating state which is fully independent of any loading by means of any test specimen or even of a loading applied externally, however, outputs a supposed measured torque. The invention in accordance with the suggested torque-measuring device therefore allows a freewheeling torque of this type to be identified, in that a measurement is carried out in the completely unloaded state for example, and the torque measured value identified or measured in each case to be compensated with the freewheeling torque identified.

Accordingly, the present invention secondly suggests a method for torque measurement which stands out on account of the fact that a freewheeling torque is initially identified and the identified torque measured value is then compensated with the freewheeling torque.

It has been established in this connection that a substantial part of the freewheeling torque is determined by means of the torque-measuring flange itself. Here, a torque-measuring flange generally stands out due to a measurement device for measuring a value which is proportional to a torque acting on the torque-measuring flange, wherein the measurement device can for example have strain gauges or other tension meters, with which a torsion of the torque-measuring flange, which is routinely proportional to a torque, can be detected. In this connection, it is to be understood that, as a measuring device for measuring a value proportional to a torque acting on the torque-measuring flange, all devices, for example also path measurements or similar, with which a value of this type can be measured correspondingly sufficiently reliably can be used.

Incidentally, it is to be understood in the present context that the term “proportional” is to be understood in the broadest sense in the present case. In particular, a reversed proportionality can also be present here. Likewise, a relatively complex functional dependency between the torque and the corresponding, measurable value can, if appropriate, be present. In a known manner, a corresponding torque can then be identified from the respective measured values by means of corresponding calculations using the functional dependency. Furthermore, it is to be understood here that the output of a torque, at least in SI units for example, is not compulsory for a desired measurement result. Rather, the output of the corresponding value which is proportional to the torque may already be sufficient in order to provide the desired measurement results in a satisfactory form.

In order therefore to reliably be able to counteract a freewheeling torque self-caused by a torque-measuring flange or in order to reliably be able to compensate a freewheeling torque of this type particularly reliaby, the present invention thirdly suggests a torque-measuring flange with a measurement device for measuring a value proportional to the torque acting on the torque-measuring flange, which torque-measuring flange stands out on account of an evaluation unit provided on the torque-measuring flange, which has means for storing a value proportional to a freewheeling torque.

In this manner, it can be ensured relatively simply that a freewheeling torque identified for a certain torque-measuring flange is only taken into account when the corresponding torque-measuring flange is also used. In this respect, a special assignment of the respective freewheeling torques to the corresponding torque-measuring flanges, which would have to be undertaken if appropriate in a complex and therefore error-prone database, can be dispensed with. A configuration of this type thus allows a torque-measuring flange to be replaced quickly and reliably, if appropriate.

Whilst the possibility and necessity of a calibration of the torque-measuring device or of the corresponding torque-measuring flange is known from the prior art, particularly also from the Internet publications cited at the beginning, but also from DE 20 2006 007 689 U1, DE 199 17 626 A1, DE 197 19 921 A1 and DE 103 06 306 A1, none of these publications provides an indication that a speed dependency is to be compensated and that this is to be realised in an advantageous manner by means of a taking into account of the freewheeling or of the zero-point displacement caused by the speed.

Preferably, the corresponding compensation means for compensating a measured value with the stored value, which is proportional to the freewheeling torque, are provided on the torque-measuring flange. A configuration of this type makes it possible to carry out a corresponding compensation directly on the torque-measuring flange already, particularly even when the same rotates. In this manner, only the measurement signal present after the compensation needs to be transmitted. Otherwise, it may, if appropriate, be necessary to transmit the value, stored in the storage means on the torque-measuring flange and proportional to the freewheeling torque, or the values, stored in the storage means on the torque-measuring flange and proportional to the freewheeling torque, to an evaluation unit in a separate step.

It has furthermore been established that the freewheeling torque is dependent on the speed, if appropriate. Here, it is assumed that this is possibly caused by air resistances or else by centrifugal forces or possibly by virtually immeasurable mounting inaccuracies or imbalances. In this respect, it has proven particularly advantageous if the storage means comprise means for storing a value proportional to a speed-dependent freewheeling torque with assignment to a speed. In this manner, a corresponding plurality of freewheeling torques can be stored in a manner dependent on the speed, which freewheeling torques then make it possible to undertake a corresponding compensation by means of suitable extra- or interpolation or other measures known per se from the prior art. Here it is also possible, instead of various measured values, to save a correspondingly already-extrapolated or—interpolated functional dependency.

Furthermore, it is accordingly advantageous if a sensor for identifying a value dependent on the speed is provided on the torque-measuring flange. In the first instance, the position at which a corresponding sensor is provided appears to be random, especially as known torque-measuring devices generally provide devices for speed measurement anyway. On the other hand, the known speed measurement devices have the corresponding sensor exclusively on a stator, such as for example a housing or a frame, as otherwise the speed or a value proportional to the speed must be transmitted separately from a rotor to an evaluation system, which routinely does not exactly rotate therewith. The present invention in this respect proceeds from this current practice, as the sensor should be provided on the torque-measuring flange which can even accordingly rotate, wherein, if appropriate, a signal transmitter, which is fixed, that is to say does not rotate therewith, outputs a signal which is to be detected by the sensor during each rotation. For example, a signal transmitter of this type can be a permanent magnet, the magnetic field of which can be detected by a Hall effect sensor or reed switch which rotates with the rotating flange. In this context, it is to be understood directly that, in this respect, any suitable sensor with which a speed can be identified sufficiently reliably is to be used advantageously.

The correspondingly identified and compensated measurement result can be sent out by the torque-measuring flange. The sending out can here take place in any known form which makes it possible to transmit a measured value or another value from a first to a second subassembly. Preferably, the sending out takes place contactlessly, so that an influence on the measurement arrangement itself can be minimised. The fixed part of the torque-measuring device can then correspondingly have a receiver which receives the signal sent out. A transmission by means of light has proven particularly advantageous, particularly if the value proportional to the speed is transmitted in a frequency-modulated manner. A transmission is then extremely low-energy, so that a very small power source is sufficient for the torque-measuring flange.

Cumulatively or alternatively to the previously described freewheeling correction, the object of the present invention is also achieved by a torque-measuring device with a torque-measuring flange and an evaluation system, in the case of which the evaluation system stands out by means of a memory for storing a zero point of the torque-measuring flange over time. Whilst in accordance with the prior art, statistical displacements of the zero point, which can be caused for example by a change in the direction of a load or other load change, by temperature fluctuations or shaking and similar, can readily be detected by means of regularly undertaken calibration procedures, drift processes caused over long periods of time cannot be detected by this, as these elude detection by means of singular calibration procedures in a manner determined by the system. Drift processes of this type can for example be linked to residual stresses present in the torque-measuring flange, which only dissipate over very long periods of time after the mechanical production of the respective torque-measuring flange. Likewise, this can be linked to stresses which are introduced into the measuring body by means of the currently followed measurement programme. It is also conceivable that this is linked to an insufficient stability of the analogue signal processing components and the analogue measured value pick-up. Specifically the lack of knowledge of the corresponding links and the very long periods of time in which the corresponding drift becomes effective have hitherto prevented a confrontation of this. Only storing the zero point as a function of time can enable the taking into account of this phenomenon.

In particular, a zero-point drift can be determined accordingly, particularly on the basis of the data saved in the memory, and an identified torque measured value can be compensated with the zero-point drift.

Preferably, the torque-measuring device has means for displaying the zero-point drift, so that an overview of the corrections undertaken remains for the user, particularly in order to be able to check the quality of the measurement. On the other hand, it is to be understood that a display of this type can be dispensed with and the corrections can be undertaken within the device without the user being bothered with a corresponding display. As it has been established, however, that each torque-measuring device is subject to a corresponding zero-point drift, it can solely be ensured that a corresponding zero-point drift is apparently not present by means of the previously explained correction and the zero points of the torque measurement statistically fluctuate around the point zero of a torque which is not present, torque=0 Nm. In this respect, the correction undertaken is also to be differentiated from calibrations which are already known per se, which act directly on the statistical fluctuations and only act in a correspondingly calibrating manner for a short time.

Preferably, the storing of the zero points takes place in the memory at a constant temperature. In this manner it can be ensured that influences on the zero-point drift caused by the temperature are minimised. In this connection, the term “constant temperature” designates a state in which the temperature changes less than a predetermined temperature difference within a predetermined time interval.

In a preferred configuration, zero points are stored for zero-point drift identification if the torque measured lies below a threshold value across a plurality of measurements. In this manner, zero points can be recorded independently of the influence of a user, so that it is possible, depending on the concrete implementation, to automatically record the zero points and, if appropriate, to also automatically undertake a corresponding compensation. As a result, a user can be relieved and the risk of operating errors can be minimised. It is to be understood that other procedures for automation can also be used, wherein the previously described procedure constitutes an approach which is relatively simple to implement and reliable.

Although, as explained previously, it is out of the question to completely avoid a drifting or creeping of the zero point, a drifting or a creeping of the zero point can be minimised by means of structural measures. To this end, it is for example suggested to form at least the regions of a torque-measuring flange which are conventionally loaded with a torque from titanium, preferably with a titanium grade between 1 and 10. Alteratively or cumulatively to this, a torque-measuring flange with a load change hysteresis below 0.03% of the nominal torque can be provided, which surprisingly likewise has a very small zero-point drift. In this manner, the necessary corrections can be minimised in terms of their absolute value, although a zero-point drift cannot be avoided without corrections of this type. On the other hand, it is to be understood that, if appropriate, a correction of the zero-point drift can be dispensed with if, by means of these structural measures, the size of the drift can be detected before or after each measurement when it is sufficiently low and by means of simple calibration measures.

It is to be understood that a corresponding memory for storing the zero points of the torque-measuring flange as a function of time on the one hand can be provided in a stationary evaluation unit of the torque-measuring device. Likewise, the memory can also be arranged at or on a corresponding torque-measuring flange so that the corresponding values and corrections are already undertaken before the transmission of a measured value to the stationary system of the corresponding torque-measuring device, as has already been explained for freewheeling correction.

Further advantages, goals and characteristics of the present invention are explained on the basis of the attached drawing in which torque-measuring devices or torque-measuring flanges according to the invention are illustrated by way of example.

In the drawing:

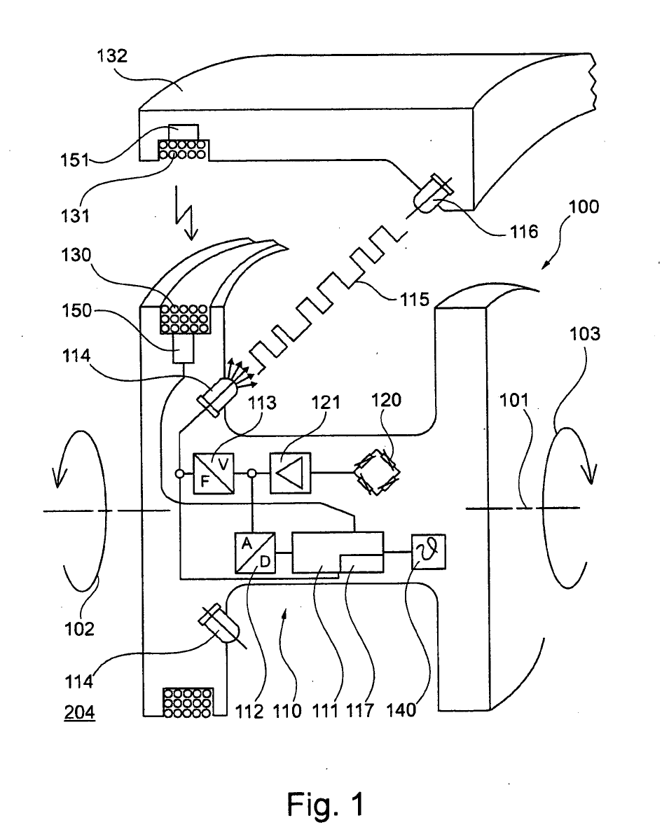

FIG. 1 shows a first torque-measuring flange according to the invention with corresponding stator in a schematic representation;

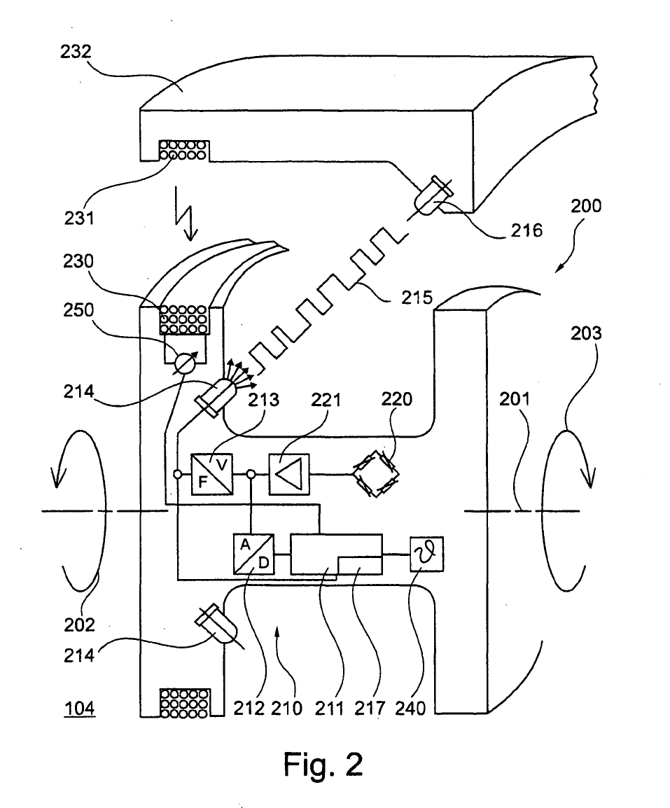

FIG. 2 shows a second torque-measuring flange according to the invention with corresponding stator in a schematic representation;

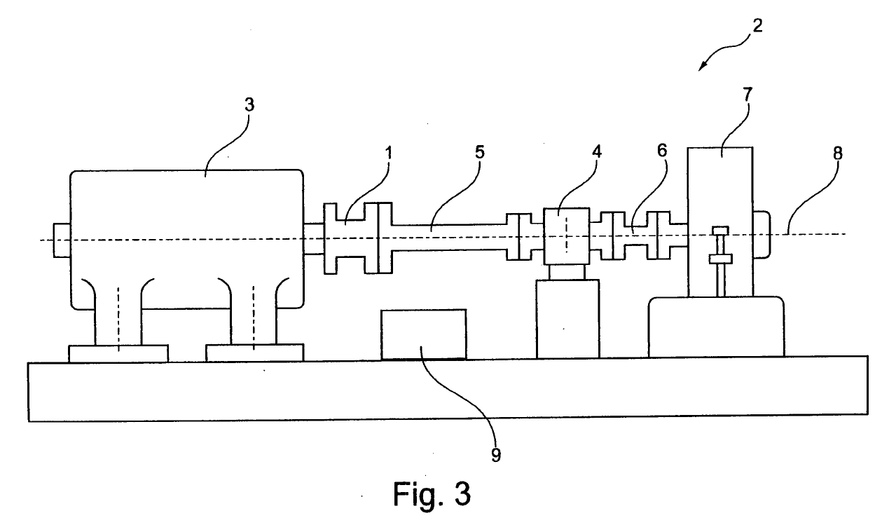

FIG. 3 shows a principal construction of a test bench with a torque-measuring device;

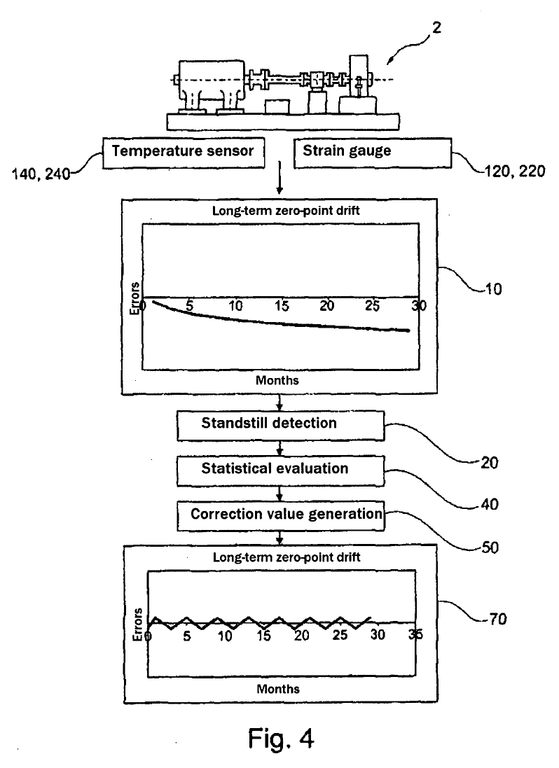

FIG. 4 shows the method flow for a determination and correction of the zero-point drift;

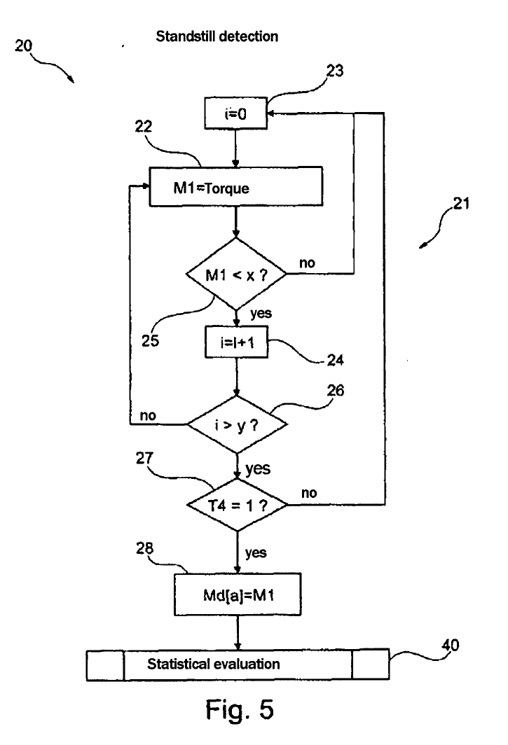

FIG. 5 shows the standstill detection detail in the method flow according to FIG. 4;

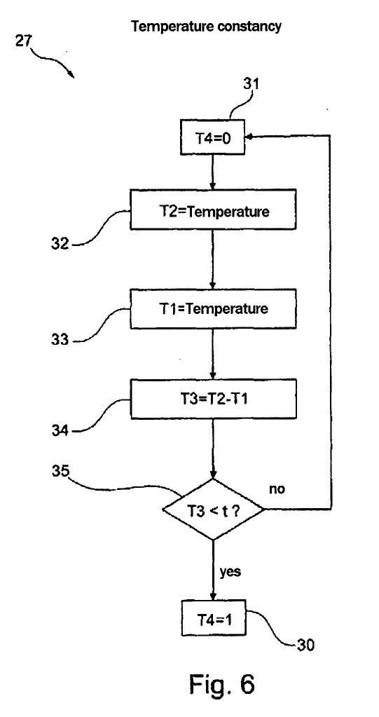

FIG. 6 shows the checking the temperature constancy detail in the method flow according to FIG. 4;

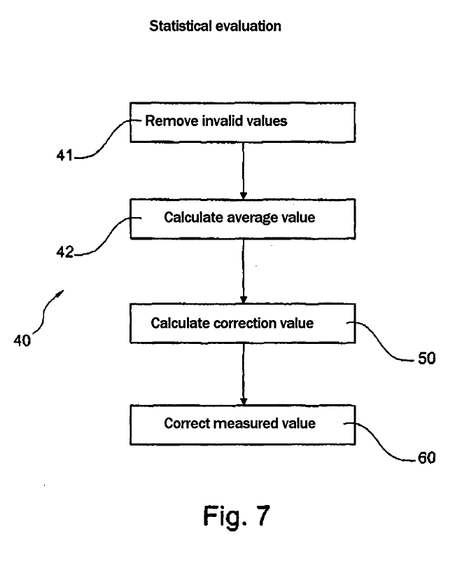

FIG. 7 shows the statistical evaluation detail in the method flow according to FIG. 4; and

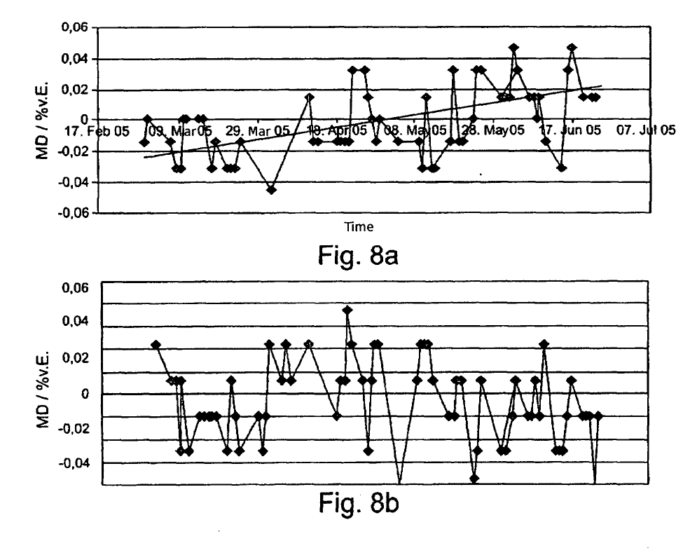

FIGS. 8 show exemplary measurement results without correction of the zero-point drift (FIG. 8a) and with correction of the zero-point drift (FIG. 8b).

The torque-measuring flanges 100 and 200 illustrated in FIGS. 1 and 2 can be provided as a torque-measuring flange 1 in the powertrain of a test bench 2, as is illustrated by way of example in FIG. 3. Here, the powertrain has a drive motor 3, such as for example an electric motor, by means of which a test specimen 4 can be driven. Here, the concrete construction of the test bench 2 can be adapted to the requirements relatively individually. In the exemplary embodiment shown in FIG. 3, the test specimen 4 is connected on the one hand via an intermediate shaft 5 to the torque-measuring flange 1, which is connected on its side facing away from the test specimen 4 to the drive motor 3 in a rotationally fixed manner, and on the other hand via an intermediate shaft 6 to a loading device 7, which can in particular be constructed as a brake, but also as a generator for example, that is to say as an electrical brake. It is to be understood that the intermediate shafts 5, 6 and also the loading device 7 can if appropriate be dispensed with. It is also possible to provide further subassemblies.

Whilst all of the rotating subassemblies of the test bench 2 rotate about a common axis 8 in the present exemplary embodiment, this is not absolutely necessary. Rather, it is also conceivable that the corresponding axes of rotation of the individual subassemblies are orientated offset with respect to one another, at an angle to one another or skew to one another.

By means of a sensor, which is not shown in detail in FIG. 3, different operating parameters of the previously described subassemblies can be detected and stored and processed in a suitable manner in an evaluation system, which comprises an evaluation device 9 in particular. Here, the evaluation system comprises corresponding measured value pick-ups or sensors on the one hand and corresponding storage or computing units on the other hand, which can be provided in particular by means of a data-processing system. On the other hand, individual measured values can also already be subjected to certain calculations, adjustments or compensations in small evaluation units directly on site.

In this respect, the drive motor 3, the torque-measuring flange 1, the test specimen 4 and the loading device 7 as well as the intermediate shafts 5 and 6, the previously described sensors and the evaluation system at the test bench 2 form a torque-measuring device, with which the behaviour of the test specimen 4 can be determined, under different loadings acting on it, particularly with respect to a torque which is changing and also as a function of a variable speed.

The torque-measuring flanges 100 or 200 shown in the FIGS. 1 and 2 in each case have an evaluation unit 110 or 210 which rotates therewith and is essentially controlled by a microcontroller 111 or 211 in each case, which can modify a measurement signal, which is measured by strain gauges 120 or 220 arranged in a bridge circuit and is amplified by means of amplifiers 121 or 221, by means of a D/A converter 112 or 212 directly in each case. The correspondingly modified signal is frequency modulated in a modulator 113 or 213 and sent out by means of light-emitting diodes 114 or 214. Here, a plurality of light-emitting diodes 114, 214 are provided in each case over the circumference of the torque-measuring flange 100, 200, so that a correspondingly frequency-modulated signal 115 or 215 is sent out sufficiently uniformly radially in all directions.

As a power source, the torque-measuring flanges 100, 200 shown in FIGS. 1 and 2 have coils which in each case rotate with the respective torque-measuring flange 100, 200 as rotor coils 130 or 230 and in which a voltage is induced via coils which are arranged as stator coils 131 or 231 in corresponding stators 132 or 232. The corresponding power is then supplied to the amplifiers 121, 221, the strain gauges 120, 220, the microcontrollers 111, 211, as well as the remaining electrical or electronic subassemblies on the respective torque-measuring flange 100, 200.

In the two exemplary embodiments, the rotor coils 130, 230 are arranged on the drive side 104 or 204, that is to say on the side of the respective torque-measuring flange 100, 200 facing the drive motor 3 (see FIG. 3). In this manner, any feedback effects which may be caused by the induction cannot influence the measurement result or only influence it in an insignificant manner, as only the torque acting from the test-specimen side 105 or 205, that is to say from the side of the test specimen 4 or from the side facing away from the drive motor 3 (see FIG. 3) is of interest in the case of the present measurement.

The stators 132, 232 in each case carry a photocell 116 or 216 which can receive the frequency-modulated signal 115, 215 and supply it to the evaluation device 9 (see FIG. 3). On account of the comprehensive distribution of the LEDs 114, 214, the photocells 116, 216 can receive the frequency-modulated signal 115, 215 at any angle of rotation of the torque-measuring flange 100, 200. In this connection, it is to be understood that instead of a sending out or instead of a transmission of a frequency-modulated light signal, a corresponding measurement result can also be sent out by the torque-measuring flange 100, 200 in any desired other manner, as long as a corresponding receiver is provided on the stator side.

By means of the signal path between the LEDs 114, 214 to the photocells 116, 216, which signal path faces diagonally from radially inwards to radially outwards at an angle smaller than 90° to an axis of rotation 101 or 102, the light cone of the LEDs 114, 214 can be used optimally and thus a maximum signal yield can be ensured with a number of LEDs 114, 214 which is as small as possible. As a result, the number of LEDs 114, 214 and thus a corresponding power requirement can be minimised.

Furthermore, a temperature sensor 140 or 240 is provided at the torque-measuring flanges 100, 200 in each case. The data of the temperature sensor 140, 240 is in each case supplied to the microcontroller 111, 211, so that the latter can undertake a heat-dependent correction of the signal output by the amplifier 121, 221 by means of the D/A converter 112, 212 from the temperature measurement of the respective temperature sensor 140, 240 on the basis of data which is stored in an EEPROM 117 or 217. On the basis of the strain gauges 120, 220, a torque, indicated by the oppositely-directed rotational-direction arrows 102, 103 or 202, 203, can thus be identified and transferred in a compensated manner with respect to the temperature. This is valid in particular also if the torque-measuring flange as a whole or the arrangement shown in FIG. 3 rotates.

For identifying a value dependent on the speed, the torque-measuring flange shown in FIG. 1 has a Hall effect sensor 150 which is connected to the microcontroller 111. Furthermore, a permanent magnet 151 is arranged on the stator 132 in the arrangement according to FIG. 1, so that the Hall effect sensor 150 outputs a corresponding signal with each revolution, from which signal the speed can readily be determined. It is to be understood that, to increase the measurement accuracy, a plurality of permanent magnets 151 can also be provided on the stator 132 distributed over the circumference and/or that instead of the Hall effect sensor, a reed switch can also be provided accordingly, for example.

The torque-measuring flange 200 shown in FIG. 2 has a voltage meter 250 for determining a value proportional to the speed, which determines the induced voltage in the rotor coil 230, which among other things depends on the speed, and supplies the microcontroller 211 with a corresponding measured value.

On the basis of corresponding data which is stored in the respective EEPROM 117, 217 and which constitutes a value proportional to a freewheeling torque, the respective microcontroller 111, 211 can output a value proportional to a speed-dependent freewheeling torque and thus accordingly compensate the measured value which is output via the respective modulator 113, 213.

It is to be understood that in the EEPROMs 117, 217 it is possible to store the parameters of a corresponding compensation function for the compensation on the one hand for example or individual freewheeling torques as a function of speed, from which a compensation can then be calculated in the individual case, on the other hand. It is also readily conceivable to provide other compensation methods in the evaluation units 110 and 210 accordingly.

It is to be understood that other methods can also be used for speed measurement. In particular, force measurements can also be undertaken, which are indicative of a speed in a manner dependent on centrifugal force. Conventional acceleration sensors can also be used accordingly, for example.

It is however apparent that the compensation does not necessarily have to be undertaken on the respective torque-measuring flange 100, 200. It can also be undertaken in the non-rotating evaluation device 9, for example. As, in practice, the respective torque-measuring flange 1, 100, 200 must be replaced on a test bench 2, depending on the requirements, and as the freewheeling torque for each torque-measuring flange 1, 100, 200 is generally individual, an assignment between the respective torque-measuring flange 1, 100, 200 and the stored value proportional to the freewheeling torque must be carried out, which assignment is relatively complex and subject to errors, wherein it is to be understood that as a result of this, as before, a portion of the goals according to the invention can be implemented.

The previous arrangement of the respective speed sensor, namely the Hall effect sensor 150 or of the voltage sensor 250 on the torque-measuring flange 100 or 200 furthermore has the advantage that a retrofitting of existing test benches 2 can be undertaken without any problems with torque-measuring flanges 100, 200 of this type, even when the test benches do not provide an independent speed measurement, as in the case of a configuration in accordance with FIG. 1 only a permanent magnet 151 or in the case of a configuration in accordance with FIG. 2 absolutely no supplementary measures are then necessary for a corresponding retrofitting.

In particular, if the compensation is provided on the respective torque-measuring flange 1, 100, 200, an external calibration of the respective torque-measuring flange 1, 100, 200, for example in a separate laboratory, is readily possible. The respective calibration data can be readily saved in the storage means on the respective torque-measuring flange 1, 100, 200. It is to be understood that calibration procedures of this type can also readily be undertaken in the case of other configurations as long as a corresponding assignment of the respective data or values is ensured.

For the determination and correction of the zero-point drift, which can be carried out readily in the evaluation units 110 and 210, if appropriate making use of memories present there, or else in the evaluation device 9 making use of memories present there, one proceeds in accordance with the method shown in FIG. 4. To this end, by means of the temperature sensors 140 or 240 and by means of the strain gauges 120 or 220, zero points, that is to say torque measured values in the case of a torque not being present, are measured and saved as a function of time in a memory (not given a reference number), which can ultimately be provided at any desired point. Cleaned of statistical fluctuations, a zero-point drift 10 results, which is to be corrected.

To this end, a standstill detection 20 is carried out (see FIG. 5), in which it is tested in a loop 21 whether a torque M1 (see reference number 22) is present below a torque threshold value x (torque threshold value enquiry 25) across y measured values (y is the number of measured values), in that a counter i, which was set to zero at the start of the measurement (reference number 23), is incremented (reference number 24) and compared with the desired number of measured values y (reference number 26). If this is the case, one proceeds from the fact that the test bench 2 is at a standstill. If the torque threshold value x is exceeded during one of the measurements, then the loop 21 is started anew at the torque threshold value enquiry 25 and the counter is once again set to zero (reference number 23). Likewise, the loop 21 is started anew if a temperature test 27 gives the result that the temperature is not sufficiently stable.

In the present exemplary embodiment, the temperature test 27 takes place by means of the querying of a temperature bit T4, which is set to 1 (reference number 30) if, following a first temperature measurement 32 (T2) and a second temperature measurement 33 (T1) following some time later, a temperature difference T3 identified during a temperature difference identification 34 is present below a temperature threshold value t (reference number 35). Otherwise, the temperature bit 30 receives the value 0 (reference number 31). In the present exemplary embodiment the first temperature T2 is measured at the beginning of the loop 21 for the standstill detection 20, whilst the second temperature T1 is measured during every pass through the loop 21, that is to say with every increase 24 of the counter. It is to be understood that, depending on the concrete embodiment, the temperatures can also be measured at other points in time in order to ensure a temperature test 27.

If the temperature is sufficiently stable in accordance with the temperature test 27, then the currently measured torque M1 is stored as zero point Md as a function of time a (reference number 28), wherein in accordance with the measurement sequence undertaken, one proceeds from the fact that the test bench 2 was at a standstill during the zero-point measurement and was not loaded by a torque and to large temperature fluctuations.

Subsequent to this, a statistical evaluation takes place, in which invalid values, such as unexpected outliers or outdated measured values are initially removed (reference number 41) and an average value is subsequently calculated (reference number 42). Subsequently, a correction value is calculated (reference number 50), for which, in addition to the average value, variation over time is also taken into account.

The corresponding correction value is subsequently applied to the respective measured values (measured value correction 60), as a result of which a long-term zero-point drift 70 can be prevented and only the statistical fluctuations of the zero points which result from the respective previous measurement situations or other conditions which are temporally currently occurring remain. This is clarified on the basis of actual measurements in FIGS. 8a and 8b, wherein FIG. 8a shows a zero-point drift of a test bench which cannot be overcome at that point in time, whilst FIG. 8b clarifies how, by means of a correction of the zero-point drift, the average value of the zero points remains constant over the same measurement period.

### REFERENCE LIST

1 Torque-measuring flange

2 Test bench

3 Drive motor

4 Test specimen

5 Intermediate shaft

6 Intermediate shaft

7 Loading device

8 Axis of rotation

9 Evaluation device

10 Zero-point drift

10 Standstill detection

21 Loop

22 Measured torque

23 Set counter to zero

24 Increase counter by 1

25 Torque threshold value enquiry

26 Comparison with number of measured values

27 Temperature test

28 Saving the zero point over time

30 Temperature bit to 1

31 Temperature bit to 0

32 First temperature measurement

33 Second temperature measurement

34 Identification of the temperature difference

35 Querying of the temperature threshold value

40 Statistical evaluation

41 Removal of invalid values

42 Calculate the average value

50 Calculate the correction value

60 Correct the measured value

70 Long-term zero-point drift

100 Torque-measuring flange

101 Axis of rotation

102 Direction of rotation

103 Direction of rotation

104 Drive side

105 Test-specimen side

110 Evaluation unit

111 Microcontroller

112 D/A converter

113 Modulator

114 LED

115 Frequency-modulated signal

116 Photocell

117 EEPROM

120 Strain gauge

121 Amplifier

130 Rotor coil

131 Stator coil

132 Stator

140 Temperature sensor

150 Hall effect sensor

151 Permanent magnet

200 Torque-measuring flange

201 Axis of rotation

202 Direction of rotation

203 Direction of rotation

204 Drive side

205 Test-specimen side

210 Evaluation unit

211 Microcontroller

212 D/A converter

213 Modulator

214 LED

215 Frequency-modulated signal

216 Photocell

217 EEPROM

220 Strain gauge

221 Amplifier

230 Rotor coil

231 Stator coil

232 Stator

240 Temperature sensor

250 Voltage sensor

1. Torque-measuring device with a torque-measuring flange and an evaluation system, at wherein the evaluation system has means for storing a value proportional to a freewheeling torque and means for the compensation of a measured value with the saved value.

2. Torque-measuring device according to claim 1, wherein the storage means are provided on the torque-measuring flange.

3. Torque-measuring device according to claim 1, wherein the compensation means are provided on the torque-measuring flange.

4. Torque-measuring device according to claim 1, wherein the storage means comprise means for storing a value proportional to a speed-dependent freewheeling torque with assignment to a speed.

5. Torque-measuring device according to claim 1, further comprising a sensor provided on the torque-measuring flange for identifying a value dependent on the speed.

6. Torque-measuring device according to claim 5, further comprising a rotationally fixed signal transmitter for a signal to be detected by the sensor during each rotation.

7. Torque-measuring device, according to claim 1, with a torque-measuring flange and an evaluation system, wherein the evaluation system comprises a memory for storing a zero point of the torque-measuring flange over time.

8. Torque-measuring device according to claim 7, wherein the evaluation system comprises means for determining a zero-point drift.

9. Torque-measuring device according to claim 8, wherein the evaluation system comprises means for displaying the zero-point drift.

10. Torque-measuring device according to claim 8, wherein the evaluation system comprises means for compensating the zero-point drift.

11. Torque-measuring flange with a measuring device for measuring a value proportional to a torque acting on the torque-measuring flange, comprising an evaluation unit provided on the torque-measuring flange which has means for storing a value proportional to a freewheeling torque.

12. Torque-measuring flange according to claim 11, wherein the evaluation unit has means for the compensation of a measured value with the saved value.

13. Torque-measuring flange according to claim 11, wherein the storage means comprise means for storing a value proportional to a speed-dependent freewheeling torque with assignment to a speed.

14. Torque-measuring flange according to claim 11, further comprising a sensor provided on the torque-measuring flange for identifying a value dependent on the speed.

15. Torque-measuring flange according to claim 11, further comprising transmission means for sending out the measurement result.

16. Torque-measuring flange, according to claim 11, wherein at least the regions which are conventionally loaded with a torque are formed from titanium.

17. Torque-measuring flange according to claim 16, wherein the titanium grade is between 1 and 10.

18. Torque-measuring flange, according to claim 11, further comprising a load change hysteresis below 0.03% of the nominal torque.

19. Method for torque measurement, wherein a freewheeling torque is initially identified and the identified torque measured value is then compensated with the freewheeling torque.

20. Torque measurement method according to claim 19, wherein the freewheeling torque is identified in a speed-dependent manner.

21. Torque measurement method according to claim 19, wherein the compensation takes place on a rotating torque-measuring flange.

22. Torque measurement method according to claim 21, wherein a compensated measurement result is sent out by the torque-measuring flange.

23. Method for torque measurement, according to claim 19, wherein a zero-point drift is initially determined and the identified torque measured value is then compensated with the zero-point drift.

24. Torque measurement method according to claim 23, wherein zero points are stored for zero-point drift identification at a constant temperature.

25. Torque measurement method according to claim 23, wherein zero points are stored for zero-point drift identification if the torque measured lies below a threshold value across a plurality of measurements.
